(19) United States
(12) Patent Application Publication
(10) Pub. No.: US 2002/0121097 A1
(43) Pub. Date: Sep. 5, 2002

(54) Temperature balance device

(76) Inventors: Gil Chiu, Taipei Hsien (TW); Ryan Chang, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/796,513

(22) Filed: Mar. 2, 2001

(51) Int. Cl. F25B 21/02; H02H 5/04; F28D 15/00; F25D 23/12

(52) U.S. Cl. 62/3.7; 62/259.2; 165/104.21; 165/104.33

(57) ABSTRACT

A temperature balance device is disclosed. The temperature balance device has a device body. Within the device body has a temperature adjusting piece, a first fan, a temperature sensor, a heat pipe, a first fin set, and a control circuit. One end of the heat pipe is adhered with a temperature adjusting piece. Another end thereof is adhered with an operating element. The first fin set is placed between the temperature adjusting piece and the first fan. The control circuit is connected to the temperature adjusting piece, first fan, and temperature sensor through leads. External the device body has a second fan and a second fin set. The second fin set is connected to a lead. The lead passes the device body to be connected to the control circuit. The second fin set is placed between the second fan and the device body with respect to a temperature adjusting piece.

### FIELD OF THE INVENTION

The present invention relates to a temperature balance device, and especially to a device which can achieve a working temperature through heat transfer and is suitable to an information system in a car or a large scale computer system.

### BACKGROUND OF THE INVENTION

The prior art temperature balance device is installed with fins and fans for reducing the temperature of the circuit components due to work continuously so that the device can be retained in a certain temperature range. Therefore, the effect to the circuit from overheating in the device is minimized. However, such kind of prior cooling device can not be retained in a preferred working temperature.

Therefore, the prior temperature balance device has some defects necessary to be improved.

### SUMMARY OF THE INVENTION

Accordingly, the primary object of the present invention is to provide a temperature balance device. The temperature balance device has a device body. Within the device body has a temperature adjusting piece, a first fan, a temperature sensor, a heat pipe, a first fin set, and a control circuit. One end of the heat pipe is adhered with a temperature adjusting piece, while another end thereof is adhered with an operating element. The first fin set is placed between the temperature adjusting piece and the first fan. External the device body has a second fan and a second fin set. However, aforesaid devices are not sufficient to well adjust the temperature in a car, such as an information system in a car or a large scale computer system. That is, if the temperature in a car is too high, the heat dissipation is not good, while if the temperature is too low, the device can be retain a proper working temperature in the system. Therefore, a control circuit is installed in the device body. The control circuit is connected to the temperature adjusting piece, first fan, and temperature sensor through leads and the temperature of the device body is sensed through the temperature sensor so as to be compared with the set temperature for determining whether the first fan, second fan, and temperature adjusting piece are necessary to be opened or closed so that the device body is retained in a proper temperature in order to avoid the first fan, second fan, and temperature adjusting piece are operated ineffectively. Therefore, the power is saved effectively and the lifetimes of the components are prolonged.

Another object of the present invention is to provide a temperature balance device, The temperature balance device has a device body. Within the device body has a temperature adjusting piece, a first fan, a temperature sensor, a heat pipe, a first fin set, and a control circuit. One end of the heat pipe is adhered with a temperature adjusting piece, while another end thereof is adhered with an operating element which can be placed interior or exterior the device body or freely moved between the interior and exterior of the device body. The operating element may be a LCD back light plate. The first fin set is placed between the temperature adjusting piece and the first fan. The control circuit is connected to the temperature adjusting piece, first fan, and temperature sensor through leads. External the device body has a second fan and a second fin set. The second fin set is connected to a lead. The lead passes the device body to be connected to the control circuit. The second fin set is placed between the second fan and the device body with respect to the temperature adjusting piece in the device body.

The various objects and advantages of the present invention will be more readily understood from the following detailed description when read in conjunction with the appended drawing.

### BRIEF DESCRIPTION OF THE DRAWINGS

FIG. 1 is a plane view of the present invention.

FIG. 2 is an exploded perspective view of the present invention.

FIG. 3 is a schematic view showing the application of the present invention.

FIG. 4 is another schematic view showing the application of the present invention.

FIG. 5 is a plane view of another embodiment in the present invention.

### DETAILED DESCRIPTION OF THE PREFERRED EMBODIMENTS

To further understand the present invention, a detail description of the present invention will be described in the following with the appended drawings. Those skilled in the art may completely understand the objects, characteristics and features of the present invention from these descriptions. However, those descriptions and the appended drawings are only used to describe the present invention instead of being used to confine the spirit and scope of the present invention defined in the appended claims.

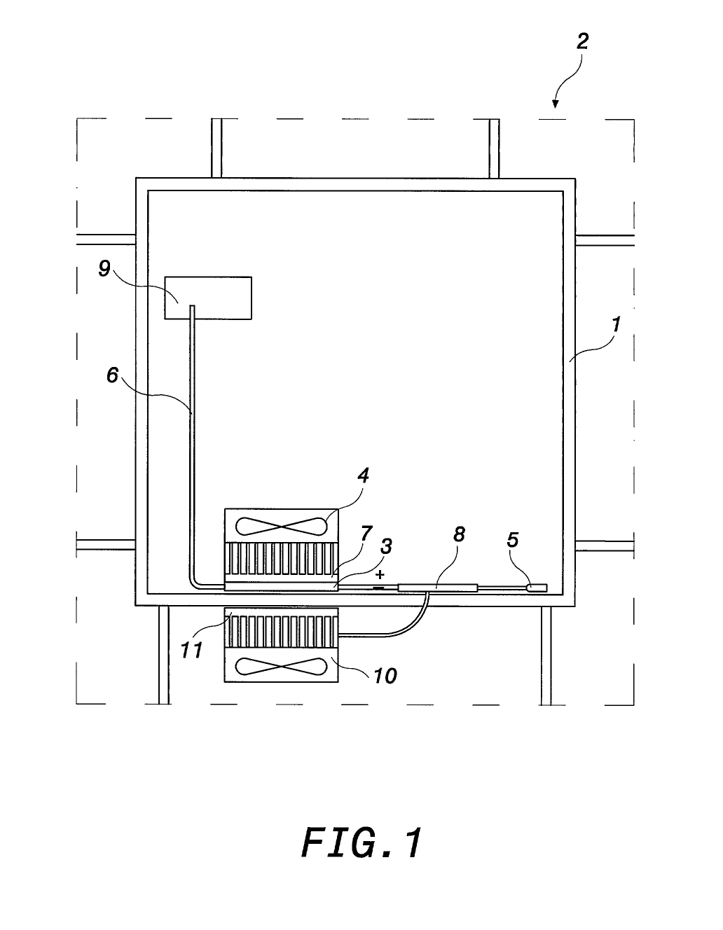

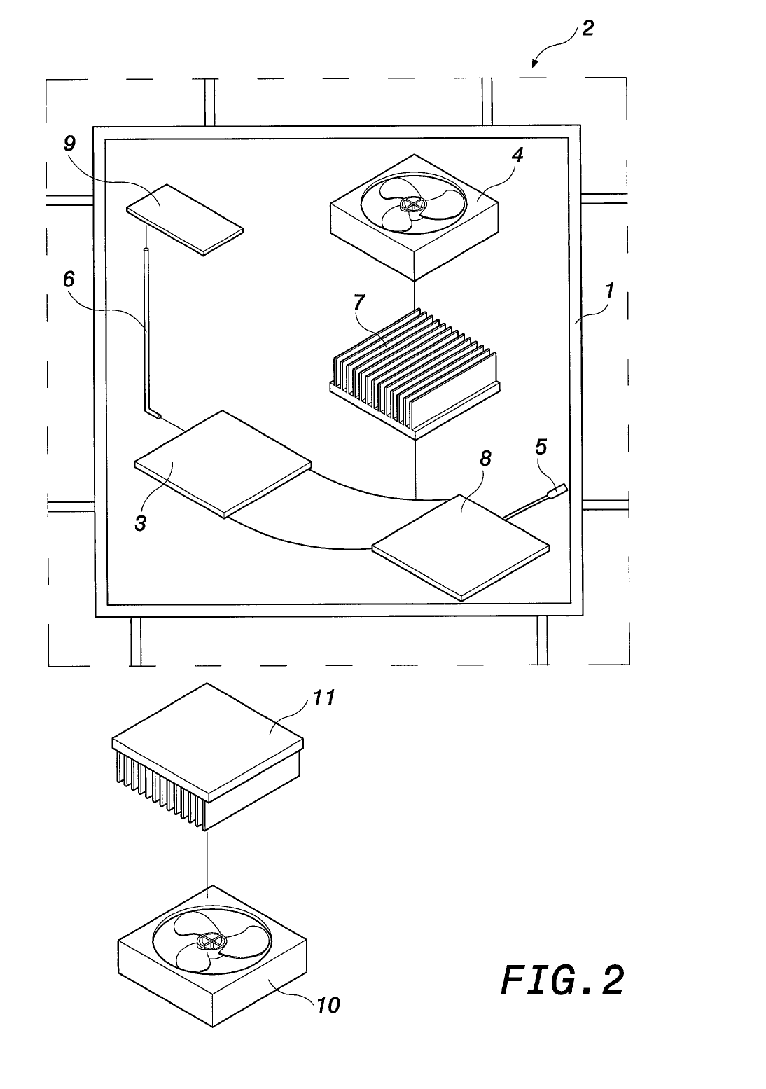

Referring to FIGS. 1 and 2, the plane view and perspective view about a temperature balance device of the present invention are illustrated. The device body 1 of the temperature balance device is fixed by screwing connection so as to have a gap with the external environment 2. The device body has a temperature adjusting piece 3, a first fan 4, a temperature sensor 5, a heat pipe 6, a first fin set 7, and a control circuit 8. The device body 1 may be an information system within a car or a large scale computer system. The heat pipe 6 can be an aluminum pipe or a copper tube and one end thereof is adhered with a temperature adjusting piece 3, while another end thereof is adhered with a LCD back light plate 9. The LCD back light plate 9 is not operated in high temperature and in low temperature. Thus, the temperature must be retained in a certain range. The LCD back light plate 9 can be placed internal or external the device body, or is freely moved between the interior and exterior of the device body. The first fin set 7 is installed between the temperature adjusting piece 3 and the first fan 4. The control circuit 8 is connected to the temperature adjusting piece 3, first fan 4, and second fan 10 through leads. A second fan 10 and a second fin set 11 are installed out of the device body 1. The second fan 10 is connected to a lead passing through the device body 1 to be connected to a control circuit 8. The second fin set 11 is placed between the second fan 10 and the device body 1 with respect to the temperature adjusting piece 3 in the device body.

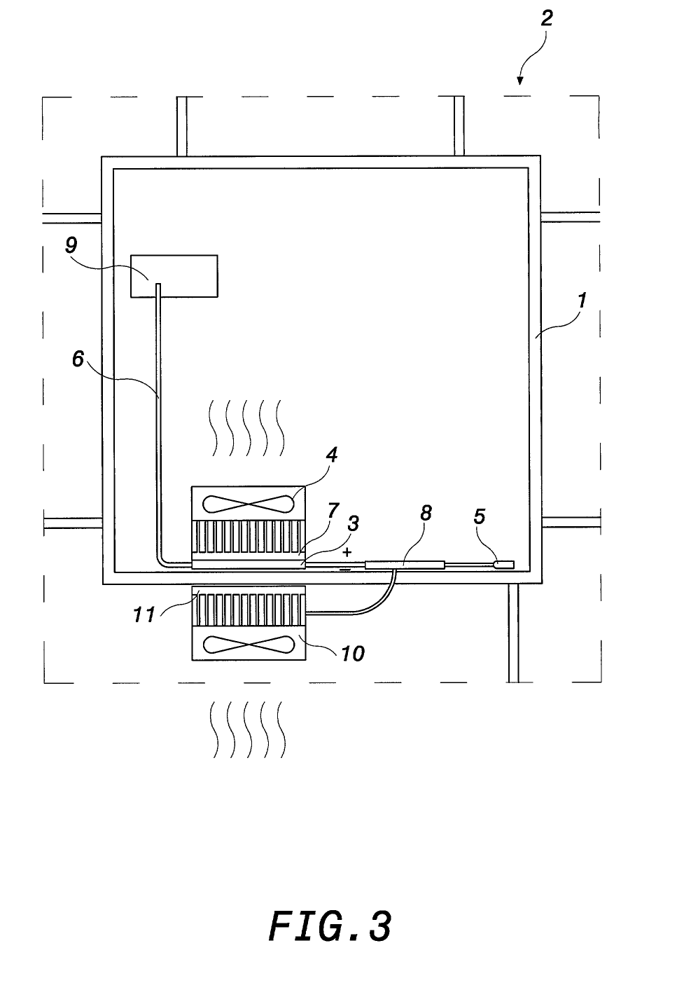

Referring to FIG. 3, a schematic view showing the application of the present invention is illustrated. The control circuit 8 serves to receive the signal from the temperature sensor 5 and then processes signals. If the temperature in the device body 1 is higher than a setting temperature stored in the control circuit 8 in advance, the heat energy from the operation of the LCD back light plate 9 can be transferred to the temperature adjusting piece 3 by the heat pipe 6 thereon. Part of the heat is absorbed by the temperature adjusting piece 3, while other heat energy is transferred to the second fin set 11 out of the device body 1 and then is transferred to the external environment 2 by the second fan 10. A gap is retained between the device body 1 and the external environment 2, and thus a preferred heat dissipation is achieved. Meanwhile, the lower temperature of the temperature adjusting piece 3 itself is transferred to the whole device body 1 so that the temperature of the device body 1 will not increase and thus is in a setting temperature range. The control circuit 8 continuously compares the temperature sensed by the temperature sensor 5 with the setting temperature range. If the temperature achieves the setting temperature range, then the temperature adjusting piece 3, first fan 4, and second fan 10 are closed. Therefore, no power is consumed. Otherwise, they operates continuously so that the device body 1 can be achieved a desired working temperature.

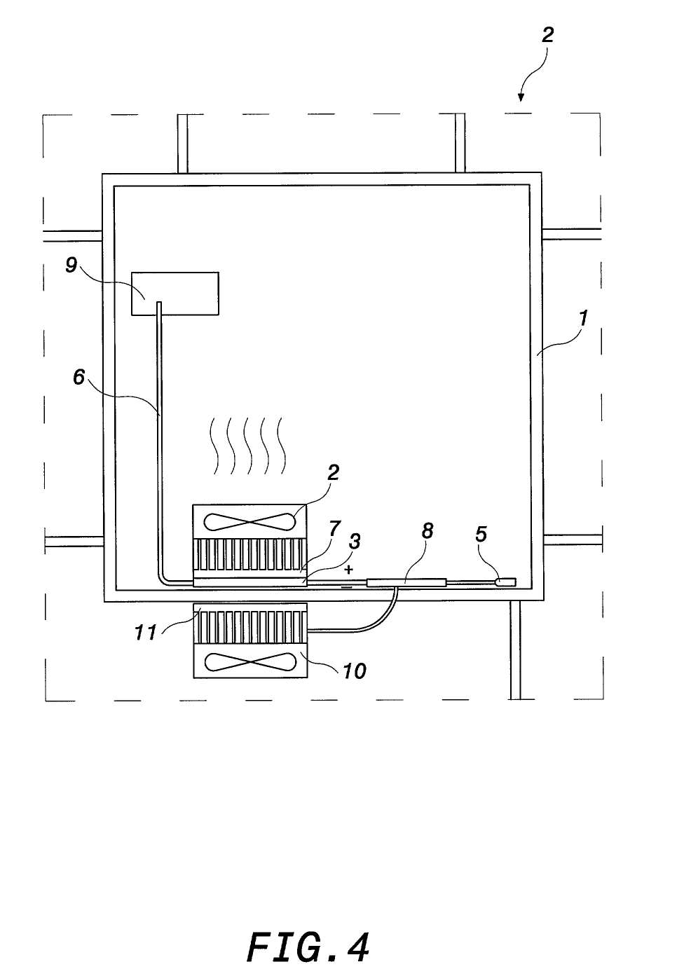

Next, if the temperature in the device body 1 is lower than the setting temperature stored in the control circuit 8 in advance (referring to FIG. 4), the control circuit 8 is set in advance so that the second fan 10 will not operate. Furthermore, the positive and negative polarities connected to the temperature adjusting piece 3 will be interchanged, then the temperature adjusting piece 3 will become a heating piece. When the LCD back light plate 9 operates so as to generate heat, since the heat pipe 6 is adhered thereon, heat can be transferred to the temperature adjusting piece 3. This heat and the heat energy generated from the temperature adjusting piece 3 are transferred to the first fin set 7, and then is dissipated in the whole device body 1 through the operation of the first fan 4 so that the temperature within the device body 1 will not be in a low temperature, and therefore, in a set temperature range. The control circuit 8 continuously compares the temperature sensed by the temperature sensor 5 with the setting temperature range. If the temperature achieves the setting temperature range, then the temperature adjusting piece 3, first fan 4, and second fan 10 are closed. Therefore, no power is consumed. Otherwise, they operates continuously so that the device body 1 achieve a desired working temperature.

Moreover, when the LCD back light plate 9 is at a normal operating temperature, the temperature adjusting piece 3 and the first fan 4 will not operate so as to avoid that the temperature adjusting piece 3 generates heat energy to induce the device body is overheated and therefore, the original heat dissipating function is disappeared.

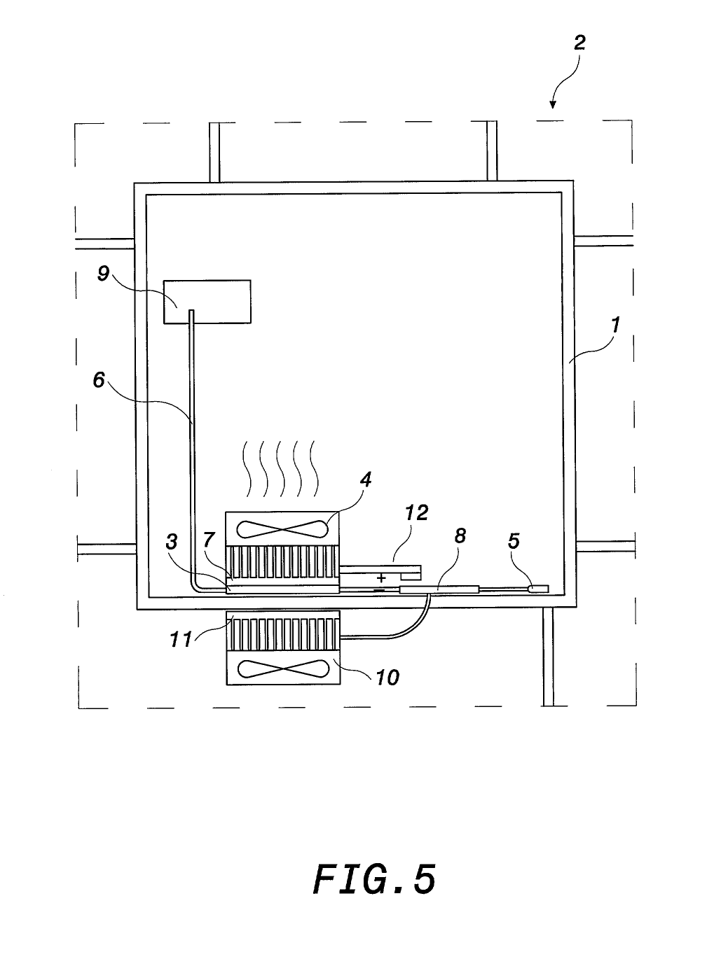

Referring to FIG. 5, a plane view of another embodiment in the present invention is illustrated. When the temperature of the device body 1 is lower than the setting temperature stored in the control circuit 8 in advance, a heating piece 12 can be added in the device body 1. The heating piece 12 may be an aluminum piece or a copper piece and is connected to the first fin set 7. Furthermore, the heating piece 12 is connected to a lead to be connected to the control circuit 8. When the LCD back light plate 9 operates and generates heat, since the heat pipe 6 is adhered thereon so that heat will be transferred to the temperature adjusting piece 3. The heat from the heating piece 12 and heat energy from the temperature adjusting piece 3 are transferred to the first fin set 7. Then, through the operation of the first fan 4, the heat is dissipated in the device body 1 so that the temperature in the whole device body can be increased rapidly to achieve the setting temperature range. The control circuit 8 compares the temperature sensed by the temperature sensor 5 with the setting temperature range. If the temperature achieves the setting temperature range, then the temperature adjusting piece 3, first fan 4, second fan 10 and heating piece 12 are closed. Otherwise, they operates continuously so that the device body 1 can be achieved a desired working temperature.

Therefore, the temperature balance device of the present invention has the following advantage:

(1) The device is retained in a working temperature.

(2) If the temperature is achieved to a working temperature, the fan and temperature adjusting piece are turned off for saving power.

(3) The lifetimes of parts are prolonged.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A temperature balance device having a device body; an interior of the device body comprising:
a temperature adjusting piece;
a first fan;
a temperature sensor;
a heat pipe having one end adhered to the temperature adjusting piece; and
a control circuit connected to the temperature adjusting piece, first fan, and temperature sensor through leads; and
an exterior the device body comprising:
a second fan connected to a lead and passing through the device body to be connected to the control circuit;
a second fin set installed in the second fan and the device body; and
being installed with respect to the temperature adjusting piece in the device body.

2. The temperature balance device as claimed in claim 1, wherein the device body is an information system within a car or a large scale computer system.

3. The temperature balance device as claimed in claim 1, wherein the device body is fixed through screwing and has a gap with external environment.

4. The temperature balance device as claimed in claim 1, wherein the heat pipe is an aluminum tube or a copper tube.

5. The temperature balance device as claimed in claim 1, wherein another end of the heat pipe is adhered with an operating element.

6. The temperature balance device as claimed in claim 5, wherein the operating element is placed interior the device body or exterior the device body.

7. The temperature balance device as claimed in claim 5, wherein the operating element is freely moved between the interior and exterior of the device body.

8. The temperature balance device as claimed in claim 5, wherein the operating element is an LCD back light plate.

9. The temperature balance device as claimed in claim 1, wherein the first fin set is externally connected to a heating piece.

10. The temperature balance device as claimed in claim 9, wherein the heating piece is connected to a lead so as to be connected to the control circuit.

11. The temperature balance device as claimed in claim 9, wherein the heating piece is an aluminum piece or a copper piece.
